(19) United States
(12) Patent Application Publication
(10) Pub. No.: US 2013/0322012 A1
(43) Pub. Date: Dec. 5, 2013

(54) Scalable Brain Boards For Data Networking, Processing And Storage

(71) Applicant: BIRCHBRIDGE INCORPORATED, Belmont, CA (US)

(72) Inventors: John Craig Dunwoody, Belmont, CA (US); Teresa Ann Dunwoody, Belmont, CA (US)

(21) Appl. No.: 13/904,912

(22) Filed: May 29, 2013

Related U.S. Application Data
(60) Provisional application No. 61/652,845, filed on May 29, 2012.

(51) Int. Cl. G06F 1/20

(52) U.S. Cl. CPC G06F 1/20
USPC 361/679.53; 29/401.1

(57) ABSTRACT

Systems, methods and other means for improving rack based systems are discussed herein. Some embodiments may provide for a module for insertion in a rack based system. The module may include a brain board, a plurality of lobe components, a network switch, and a power lobe component. The plurality of lobe components may be coupled to the brain board and may each be configured to support a variable composition of processing and storage elements. Furthermore, the module may be configured to thermally couple with the rack based system to receive cooling from the rack based system.

### CROSS REFERENCE TO RELATED APPLICATIONS

This application claims the benefit of U.S. Provisional Application No. 61/652,845, titled “Scalable Brain Boards for Data Networking, Processing and Storage,” filed May 29, 2012, which is incorporated by reference herein in its entirety.

### FIELD

Embodiments disclosed herein are related to architectures for components, including those related to rack mounted data networking, processing, and storage systems.

### BACKGROUND

Hardware, software and firmware, sometimes referred to herein as “components” can be configured to perform “cloud” and other types of computing functionality. Often, the components are installed into racks. For example, a server computer may have a rack-mountable chassis and installed into the same rack as other computing components.

Conventional computer rack systems offer flexibility and modularity in configuring hardware to provide data networking, processing, and storage capacity, but through applied effort, ingenuity, and innovation, solutions to improve such systems have been realized and are described herein.

### BRIEF SUMMARY

Systems and related methods are provided herein that may allow, among other things, commercial off-the-shelf (“COTS”) chip-scale hardware components provide cloud and other network-based functionality, including general-purpose data networking, processing, and storage (“NPS”) capacity. For example, some embodiments discussed herein can improve efficiency by 100×-1000× or more. To realize these improvements at the system level, some embodiments can leverage new, more efficient hardware and software structures for integrating chip-scale components into complete, deployable, modular systems.

By improving efficiency in multiple areas, including waste-heat management, power conversion and network topology, embodiments discussed herein can dramatically reduce system manufacturing costs and operational energy, space, and maintenance requirements per unit of deployed NPS capacity. These improvements can be used in both military and civilian applications of scalable data systems.

Some embodiments of the components discussed herein can be configured and combined to create scalable pools of virtualized data NPS capacity, among other things, for cloud-style agile provisioning to a dynamic set of concurrently running applications. For example, some embodiments can be configured to deliver dynamically sharable virtualized pools of general-purpose NPS capacity at dramatically lower total lifecycle-cost per unit of capacity, relative to other contemporary designs.

In some embodiments, the basic unit of scalability is an integrated hardware, firmware and/or software module, sometimes referred to herein as a “brain board,” that provides, for example, NPS capacity. A single system can scale incrementally from a single brain board up to thousands of interconnected brain boards. In some embodiments, NPS capacity from each brain board can be aggregated into, for example, three system-wide provisioning pools: one for networking (e.g., high-radix Ethernet switch), one for processing (e.g., many-core system-on-a-chip (“SOC”) with integrated Ethernet interfaces), and one for storage (e.g., through-silicon via (“TSV”) stacked volatile and nonvolatile memory devices). For example, some embodiments may enable enables higher-efficiency systems ranging from compact embedded units up to warehouse-scale datacenters, built on a simplified hardware foundation using these provisioning pools. The functionality provided by the provisioning pools can be provided by components referred to herein as “lobe components” that can include the circuitry and other components useful for providing, for example, networking, processing and/or storage, among other things. Because the lobes can be discrete components, they can enable each brain board, chassis and the system as whole to be both scalable, configurable, and modular, which can translate to improved, application-specific NPS capacity that can be deployed in datacenters and mobile air, surface, subsurface, sea-based, and underwater platforms, within key resource constraints including capital budget, power, and space.

In some embodiments, each brain board can comprise electronic, photonic and/or any other suitable hardware components that are packaged together. The brain board can be configured to slide or otherwise be inserted into module bays in a chassis. For datacenter applications, the chassis may be comparable in scale to a conventional datacenter rack cabinet. For embedded/mobile platforms, smaller and/or implementation-specific chassis size(s) can be utilized.

An efficient fiber-cable interconnection scheme can enables incremental scaling of a single system from one chassis up to hundreds of chassis, each including one or more brain boards, without changing routing or connections of existing cables. For example, multiple chassis can be arranged back-to-back in rows.

Each chassis can be configured to provide one or more of the following services to each brain board: mechanical support (e.g., via module bay), power and networking connections (e.g., via backplane at rear of module bay), and/or touch cooling (e.g., via cold-plates that define top and bottom of module bay), among other things. For example, a chassis can be configured to incorporate two or more independent, self-contained pumped liquid multi-phase cooling (“PLMC”) refrigerant circuits in a redundant and/or any other suitable configuration. The waste-heat rejection from each installed brain board to the chassis can be exclusively via touch, from thin flat heat-spreader plates that define the top and bottom planes of the brain board, to the cold-plates that define the top and bottom of the chassis' module bay. Brain boards do not need to contain coolant plumbing in accordance with some embodiments, and accordingly brain board insertion/removal can be performed without having to make/break a coolant connection, thereby reducing coolant leak risks.

Each brain board can be configured as a “sandwich” of top and bottom sections. For example, the top and/or bottom section of the brain board can each comprise a rectangular and/or other shaped printed circuit board (“PCB”) onto which electronic, photonic and/or any other suitable components are mounted. One or more of the components' height(s) above each PCB can be configured to be as small and uniform as possible and/or necessary for a given application. For example, a “primary side” of each PCB of the brain board can be configured to have mounted thereon the components with the highest waste-heat dissipation, and lower-dissipation components may be mounted on the “secondary side” of the PCB.

Each section of the brain board can also or instead comprise a heat-spreader plate. In some embodiments, one or more of the heat-spreader plates can be thin and flat with rectangular dimensions or otherwise matching the shape of the PCB. The primary side of the PCB can be mounted directly and/or otherwise thermally coupled to the heat-spreader plate. For example, thermal interface material may be used to thermally connect the components of the brain board directly to the heat-spreader plate.

Top and bottom sections of the brain board can also or instead be connected back-to-back via compression-spring posts. When the brain board is inserted into a module bay of a chassis, the springs can be compressed and exert a force causing the brain board's heat-spreader plate(s) to push against the cold-plates at top and bottom of the chassis' module bay(s), to maximize thermal contact, provide mechanical stability, and dissipate the heat generated as a result of the brain board's functionality.

On each brain board, one or more lobe components may be included. For example, each lobe component may include at least one highly integrated system-on-chip (“SoC”) processor that integrates at least one central processing unit (“CPU”), graphical processing unit (“GPU”), and/or networking capabilities on a single chip. Additionally or alternatively, each lobe component may include one or more memory units, including volatile and/or nonvolatile memory components, which may be stacked in a three dimensional manner and/or otherwise disposed thereon in any suitable manner. Additional examples of components that may be included in each lobe component can include, for example, highly integrated optoelectronics, integrated high-radix electronic and/or optoelectronic network routers, highly scalable network topologies, pumped liquid multiphase cooling (“PLMC) component(s), and/or high-efficiency power converters, among other things.

In some embodiments, the chassis that receives the brain board(s) with the lobe component(s) thereon can be configured to include a plurality of sections, including a first section that pumps integrated liquid-refrigerant from the bottom of chassis. For example, two coolant pumps having dual-independent-circuit configuration can be included in each chassis. Each pump can be configured to receive coolant from a return-pipe network, and feed a supply-pipe network delivering coolant to one of two circuits in each cold-plate that form the module bays that receive brain boards.

The chassis can also include a second section that includes a stacked set of NPS module bays, each configured to receive one or more brain boards. The module bays can be spaces defined (at least partly) by cold-plates. For example, the cold-plates may be thin, horizontal and arranged in a vertical array with uniform and/or non-uniform spacing there between. Each cold-plate can be configured to function as an evaporator with, for example, two independent sets of one or more thin flat-tube strips. Each set of strips can be configured to carry coolant in parallel internal microchannels, from an inlet manifold on a first side of the chassis, across to an outlet manifold integrated into another side of the chassis. One or more of an installed brain board's heat-spreader plates can be configured to contact one or more (e.g., all) of the strips in the adjacent cold-plate. If coolant flow stops, due to maintenance or failure, all components of the brain board may continue to be cooled by the chassis, albeit at reduced capacity in some embodiments. To provide increased space-efficiency, the vertical pitch of the chassis' module bays can be configured to be, for example, 0.75 of an inch or less. A backplane system at rear of chassis can be provided and, in some embodiments, span the module bays, providing power-inlet and network connections at rear of each bay.

In some embodiments, the chassis can include a third section that is configured to facilitate heat-rejection at the top of the chassis. For example, a vapor-supply pipe network with liquid separators can be configured to carry refrigerant vapor from the cold-plate outlet manifolds to the top of the chassis. (As referred to herein, “top” and “bottom” refer to the side of the chassis relative to the pull of gravity with lighter material floating or otherwise moving “up” to the top and heavier materials settling or otherwise moving “down” to the bottom.) A liquid and/or other type of return pipe network can be configured to carry refrigerant liquid from the top of the chassis and the liquid separators, back down to the refrigerant-pump inlets. Options for heat rejection from top of chassis include condensers that transfer heat directly to the surrounding environment, and multistage configurations with a heat exchanger connected to a next-level coolant loop.

These characteristics as well as additional features, functions, and details of various corresponding and additional embodiments, are also described below.

### BRIEF DESCRIPTION OF THE DRAWINGS

Having thus described some embodiments in general terms, reference will now be made to the accompanying drawings, which are not necessarily drawn to scale, and wherein:

FIG. 1 illustrates an embodiment of a rack system including a cooled universal hardware platform according to some example embodiments;

FIG. 1A illustrates an example brain board in accordance with some embodiments discussed herein;

FIG. 1B illustrates an example capacity providing lobe component in accordance with some embodiments discussed herein;

FIG. 2 illustrates a portion of the side of the rack system and the cooled universal hardware platform, according to some example embodiments;

FIG. 3 illustrates an example embodiment of a rack system, and specifically the rear portion and the open side of the rack, and the cooled universal hardware platform according to some example embodiments;

FIG. 4 illustrates an embodiment of a cooled partition found within the rack system according to some example embodiments;

FIG. 5 illustrates an embodiment of several cooled partitions making up the module bays as viewed outside of the rack system according to some example embodiments;

FIG. 6 illustrates an example of where components to cool the module bays may be located in a rack system to according to some example embodiments;

FIGS. 7 and 8 illustrate embodiments of a module fixture that includes circuit boards and components that make up a functional module in a brain board according to some example embodiments;

FIGS. 9 and 10 illustrate embodiments of the module fixture from a side view in an uncompressed and compressed state, respectively, according to some example embodiments;

FIGS. 11 and 12 illustrate embodiments of a module fixture for a rack power board insertable into the rack power section of the rack system according to some example embodiments;

FIG. 13 illustrates an arrangement of a plurality of rack units, to provide interconnection thereof for a robust computing environment according to some example embodiments;

FIGS. 14A and 14B show example views of a thermal plate that includes a frame and a heat exchanger insert, according to some example embodiments; and

FIGS. 15A and 15B show example views of a thermal plate having a frame including multiple insert receptacles for supporting a corresponding number of heat exchanger inserts, according to some example embodiments.

### DETAILED DESCRIPTION

Embodiments will be described more fully hereinafter with reference to the accompanying drawings, in which some, but not all embodiments contemplated herein are shown. Indeed, various embodiments may be implemented in many different forms and should not be construed as limited to the embodiments set forth herein; rather, these embodiments are provided so that this disclosure will satisfy applicable legal requirements. Like numbers refer to like elements throughout.

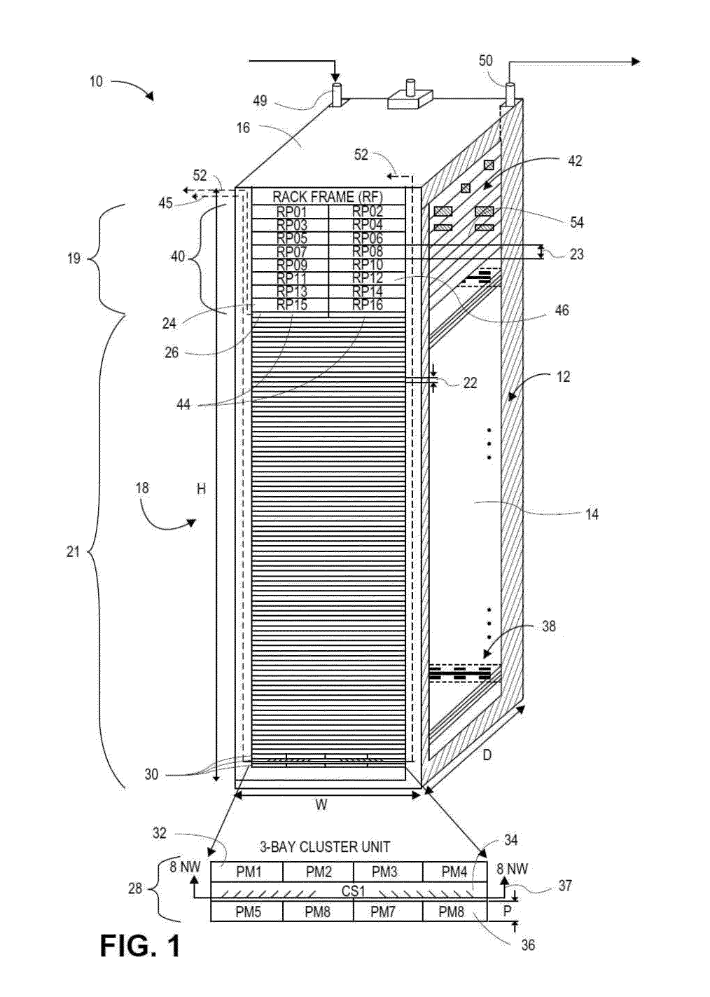

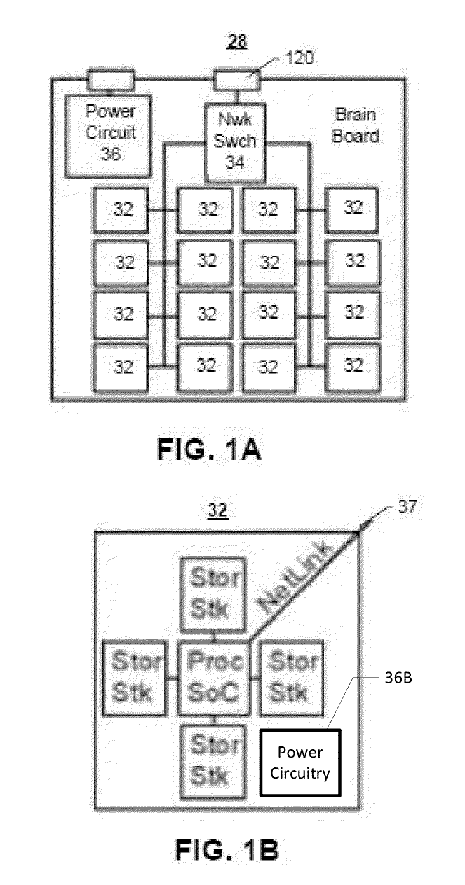

Some embodiments discussed herein generally relate to architectures for a scalable modular data system. For example, some embodiments may include a rack system, such as rack system 10 shown in FIG. 1, that may be configured to receive one or more brain boards and/or other types of modules. The rack system described herein can be configured to provide physical support, power, and cooling, among other things, for the brain boards and lobe components contained thereon. As referred to herein, lobe components may include, for example, the circuitry and/or other hardware, software and/or firmware used to facilitate the computer functionality discussed herein. In some embodiments, each lobe component can be configured to be specialized for a particular functionality, such as data processing, network serving, cloud storage, etc. In this regards, each brain board can be specialized to perform one type of function (e.g., by having homogenous lobe components) and/or be multi-functional (e.g., by having heterogeneous lobe components and/or non-specialized lobe components). The rack system can also be configured to provide a set of interfaces for the brain boards or modules based on, for example, mechanical, thermal, electrical, and communication protocol specifications. Moreover, the rack system described herein may be easily networked with a plurality of instances of other rack systems to create a highly scalable modular architecture.

Rack system 10 can include an optional rack power section 19. Optional rack power section 19 may be omitted and/or reduced in embodiments where one or more brain boards includes lobe components configured to provide the functionality traditionally performed by a rack power section, such as rack power section 19. For example, one or more power lobe components can be configured to receive a power of a first type and provide the power needed by the other lobe components of the respective brain board onto which the lobe component is located. In some embodiments, a power lobe component can be configured to provide power to a plurality of brain boards' components and/or an entire brain board can be dedicated to functioning as a power section.

Rack system 10 may also include universal hardware platform 21, which may include a universal backplane mounting area 14. The rack system 10 may further include perimeter frame 12 having a height ‘H’, width ‘W’, and depth ‘D.’ In some embodiments, perimeter frame 12 may include structural members around the perimeter of the rack system 10 and may otherwise be open on each vertical face. In other embodiments, some or all of the rack's faces or planes may be enclosed, as illustrated by rack top 16.

The front side of rack system 10, rack front 18, may include a multitude of cooled partitions substantially parallel to each other and at various pitches, such as pitch 22 (P), where the pitch may be equal to the distance from the first surface of one cooled partition to the second surface of an adjacent cooled partition. The area or volume between the adjacent partitions defines a module bay, such as module bay 24 or module bay 26, which may each receive a brain board. The module bays may all be uniform or have different sizes based on their respective pitches, such as pitch 22 corresponding to module bay 26 and pitch 23 corresponding to module bay 24. The pitch may be determined any number of ways, such as between the mid-lines of each partition, or between the inner surfaces of two consecutive partitions. In some embodiments, when the pitch varies among the module bays, the pitch 22 can be a standard unit or distance of height, such as 0.75 inches or less, and variations of the pitch, such as pitch 23, may be a multiple of the pitch 22. For example, pitch 23 can be two times the pitch 22, where pitch 22 is the minimum pitch based on module or other design constraints.

Rack system 10, and specifically universal hardware platform 21, may be configured to include a multitude of brain boards. Each brain board may include one or more lobe components configured to provide data processing capacity, data storage capacity, data communication capacity, and/or power management capacity, among other things. In some embodiments, rack system 10 may provide physical support, power, and cooling for each brain board that it contains. In that sense, a brain board and its corresponding backplane may correspond to a rack unit model. The rack unit model defines a set of interfaces for the brain board, which may be provided in accordance with mechanical, thermal, electrical, and communication-protocol specifications. Thus, any brain board that conforms to the interfaces defined by a particular rack unit model may be installed and operated in a rack system that includes the corresponding service unit backplane. For example, the brain board backplane may mount vertically to universal backplane mounting area 14 and provide the connections according to the rack unit model for all of the lobe components that perform the functions of the brain board.

FIG. 1A shows an example brain board, namely brain board 28 configured to include sixteen capacity providing lobe components 32, network switch component 34 and power lobe component 36. Capacity providing lobe components 32 can be, for example, COTS chip-scale hardware components configured to provide NPS capacity and/or any other functionality.

In some embodiments, one of capacity providing lobe components 32 can be configured to function as a management lobe included on brain board 28, the chassis (e.g., rack system 10), and/or any other component of the larger system. The management lobe, for example, can be configured to provide low level power and/or hardware control of the other capacity providing lobe components 32.

Brain board 28 may slide into its respective slot within the module bay and connect into a service unit backplane, such as cluster unit backplane 38. The cluster unit backplane 38 may be fastened to perimeter frame 12 in universal backplane mounting area 14.

In some embodiments, network switch component 34 may include a plurality of network lines exiting out of the front of network switch component 34 toward each side of the rack front 18. For simplicity, only one network switch (e.g., network switch component 34) is shown; however, it can be appreciated that a multitude of switches may be included in rack system 10. Thus, the cables or network lines for every installed switch may run up the perimeter frame 12 and exit the rack top 16 in a bundle, as illustrated by net 52 in FIG. 1.

In various embodiments, some or all of the brain boards, such as brain board 28 including the capacity providing lobe components 32 and the network switch 34, are an upward-compatible enhancement of mainstream industry-standard high performance computing (HPC)-cluster architecture. This enables one hundred percent compatibility with existing system and application software used in mainstream HPC cluster systems, and is immediately useful to end-users upon product introduction, without extensive software development or porting. Thus, implementation of these embodiments includes using COTS hardware and firmware whenever possible, and does not include any chip development or require the development of complex system and application software. As a result, these embodiments dramatically reduce the complexity and risk of the development effort, improve energy and cost efficiency, and provide a platform to enable application development for concurrency between simulation and visualization computing to thereby reduce data-movement bottlenecks. The efficiency of the architecture of the embodiments applies equally to all classes of scalable computing facilities, including traditional enterprise-datacenter server farms, cloud/utility computing installations, and HPC clusters. This broad applicability maximizes the opportunity for significant improvements in energy and environmental efficiency of computing infrastructures. In some embodiments, some or all of the brain boards may also include custom circuit and chip designs.

Furthermore, in some embodiments, power lobe component 36 may enable more flexibility and power efficiency than traditional power supply systems. For example, power lobe component 36 may be configured to receive 277 volts AC (e.g., single phase) and convert to approximately 1 volt DC. Furthermore, some embodiments may enable protection circuitry to be building-wide, rectification to be done at the chip-level and/or voltage conversion performed at the chip-level. In doing so, multiple DC-to-AC-to-DC conversions (and the associated power losses) can be avoided. Power lobe component 36 may also be configured to provide some energy storage functionality. For example, a battery and/or capacitor (such as a super capacitor) can be included in power lobe component 36 and provide emergency power should there be a power failure and/or maintenance needed. In this regard, localized, brain board power sources may provide system-wide back-up power sources time to come online (e.g., 30 seconds, a minute) without risking any loss in functionality.

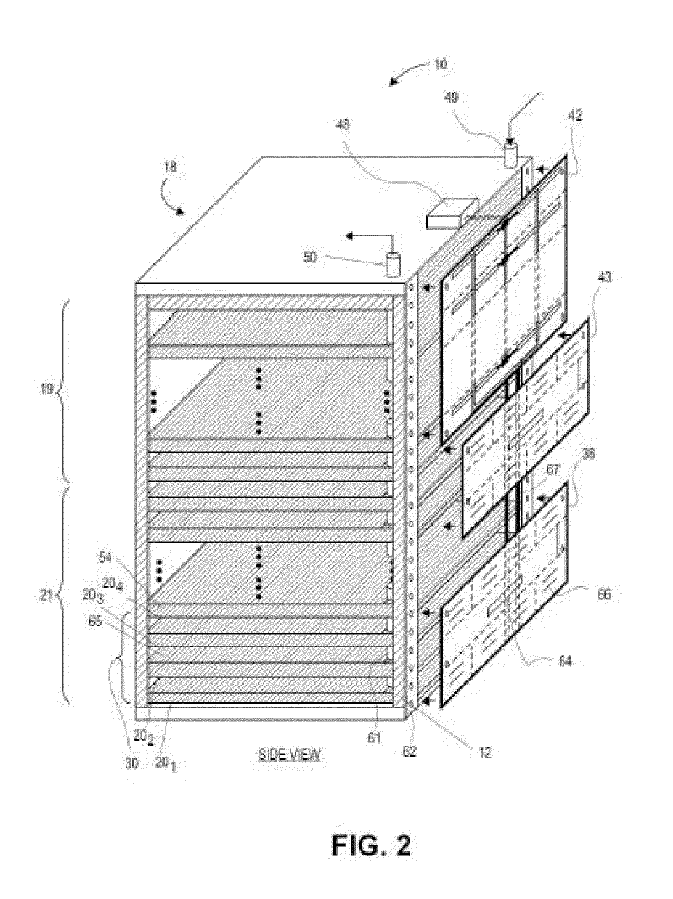

Network switch component 34 may be any suitable switch and, in some embodiments, include a backplane connector (BPC) 120 that may connect the network switch component 34 to cluster unit backplane 38 (as shown in FIG. 2). In some embodiments, the BPC 120 may include at least sixteen management ports to connect to downstream and/or upstream processing brain boards, among other things. Network switch component 34 may be configured to enable communications (e.g., via Ethernet) with other brain boards, lobe components or rack systems, to inquire about or answer inquiries regarding power status, temperature, or other conditions for various components. Network switch component 34 may include a management switch chip (e.g., an Ethernet switch) to enable Ethernet or other communications. In an example embodiment, network switch component 34 may also or instead include a high performance network chip (e.g., an Ethernet or InfiniBand chip). The high performance network chip may be a standard thirty six port chip and include sixteen ports assigned to communication with downstream processing modules, with some or all of the remaining twenty ports being assigned to communication with external networks (e.g., via Ethernet), and/or with upstream switching modules. In an example embodiment, zero to two ports may be used for connection to an optional gateway module. The gateway module may then connect to an Ethernet or other input/output interface to external networks. The other eighteen to twenty ports may be coupled to a fiber optic input/output interface to connect to external networks and/or with upstream switching modules. In some embodiments, the other eighteen to twenty ports may be connected to the fiber optic input/output interface via an optional electro-optic converter.

FIG. 1B shows an example configuration of a capacity providing lobe component 32. In various applications, capacity providing lobe component 32 can include various components to enable various functionality. For example, a capacity providing lobe component 32 can include a central processing component, such as a SoC, and/or various storage components, such as storage stacks, as shown in FIG. 1B. In other embodiments, one or more of the storage stacks may be replaced with additional processing components. The central processing component may manage the functionality of the capacity providing lobe component 32 and communicate using a network link, such as link 37.

In some embodiments, lobe component 32 may also or instead include one or more power circuits, such as power circuitry 36B. Power circuitry 36B may enable some or all of the functionality discussed in connection with power lobe component 36 shown in FIG. 1A (e.g., convert AC-to-DC power). Alternatively, power lobe component 36 can be configured to work in conjunction with power circuitry 36B by, for example, converting to a lower DC voltage to be used by the other components of lobe component 32. As another example, both power circuitry 36B and power lobe component 36 can be configured to perform the same and/or similar functionality for different components (e.g., power circuitry 36B providing power in a form needed by the other components of lobe component 32 and/or power lobe component 36 providing power in a form needed by the network switch).

In this regard, various capacity providing lobe components 32 may be implemented on a single brain board 28 to provide data networking, processing, and/or storage capacity, among other things, in a variety of ways, using any variation in the types and numbers of capacity providing lobe components 32, which may have their own individual compositions and configurations. Based on the application, a larger or smaller number of processing and/or storage chips or modules may be included in the capacity providing lobe components 32 of any given brain board 28. For applications that require only a small amount of network throughput per unit of processing, a large number of processing chips or modules may be included in the capacity providing lobe components 32 and/or brain board 28. For different applications that require a much larger amount of network throughput per unit of processing, a single processing chip or module per network endpoint may be included in the capacity providing lobe components 32 and/or brain board 28. Similarly, for storage of relatively “cold” data, where each storage element is accessed relatively infrequently, a very large number of storage chips or modules may be included in the capacity providing lobe components 32 and/or brain board 28. Conversely, for relatively “hot” data where each storage element is accessed very frequently, a single storage chip or module may be included in the capacity providing lobe components 32 and/or brain board 28. Therefore, based on the particular application, some embodiments can provide optimized configurations of types of capacity providing lobe components 32 on each brain board 28 and/or types of brain boards 28 in each chassis (e.g., rack 10).

In embodiments where some or all of the power management functionality is not performed by the brain board(s) 28, optional rack power section 19 of rack system 10 may include rack power and management units 40. For example, rack and power management units 40 may be composed of two rack management modules 44 and a plurality of rack power modules 46 (e.g., RP01-RP16). In other embodiments (not shown) the rack and power management units may instead comprise a brain board dedicated to rack power management. Whether rack management modules 44 or rack power lobes of a brain board are implemented, network connectivity may be provided to every component installed in rack system 10. This includes every module and/or lobe component installed in universal hardware platform 21, and every module and/or lobe component of rack power section 19. Management cabling 45, for example, can provide connectivity from rack management modules 44 to devices external to rack system 10, such as networked workstations or control panels (not shown). This connectivity may provide valuable diagnostic and failure data from rack system 10, and in some embodiments provide an ability to control various brain boards and modules within rack system 10.

As with the backplane boards of universal hardware platform 21, the back plane area corresponding to rack power section 19 may be utilized to fasten one or more backplane boards. In some embodiments, rack power and management backplane 42 can comprise, for example, a single backplane board with connectors corresponding to their counterpart connectors on each of rack management modules 44 and rack power modules 46 of rack power and management unit 40. Rack power and management backplane 42 may then have a height of approximately the height of the collective module bays corresponding to the rack power and management unit 40. In other embodiments, rack power and management backplane 42 may be composed of two or more circuit boards, with corresponding connectors.

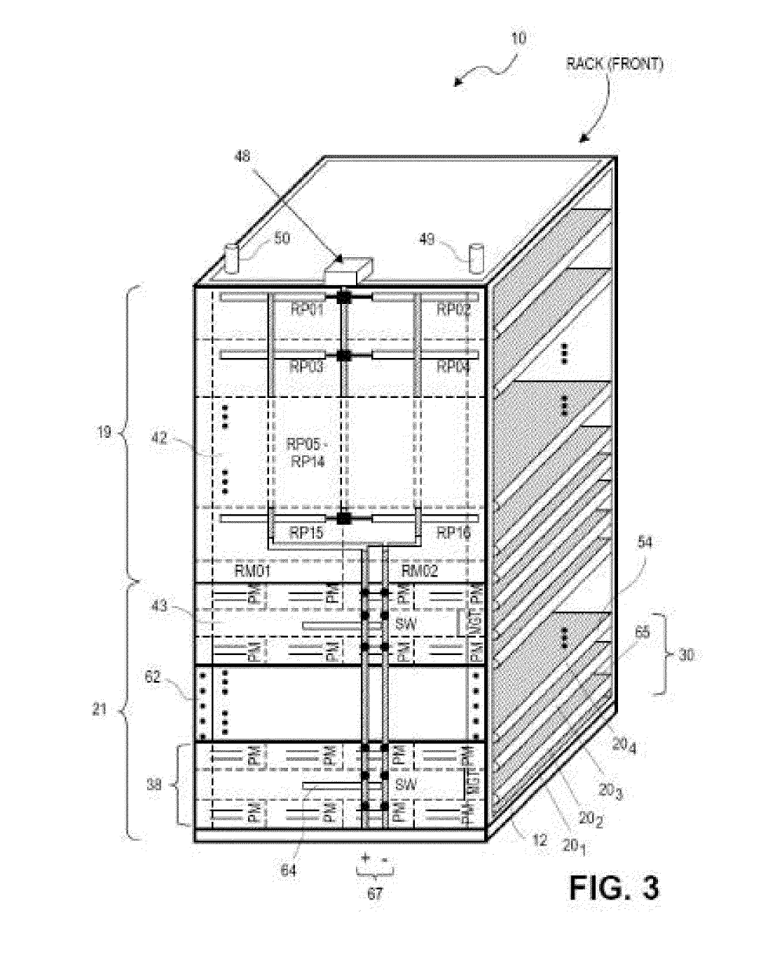

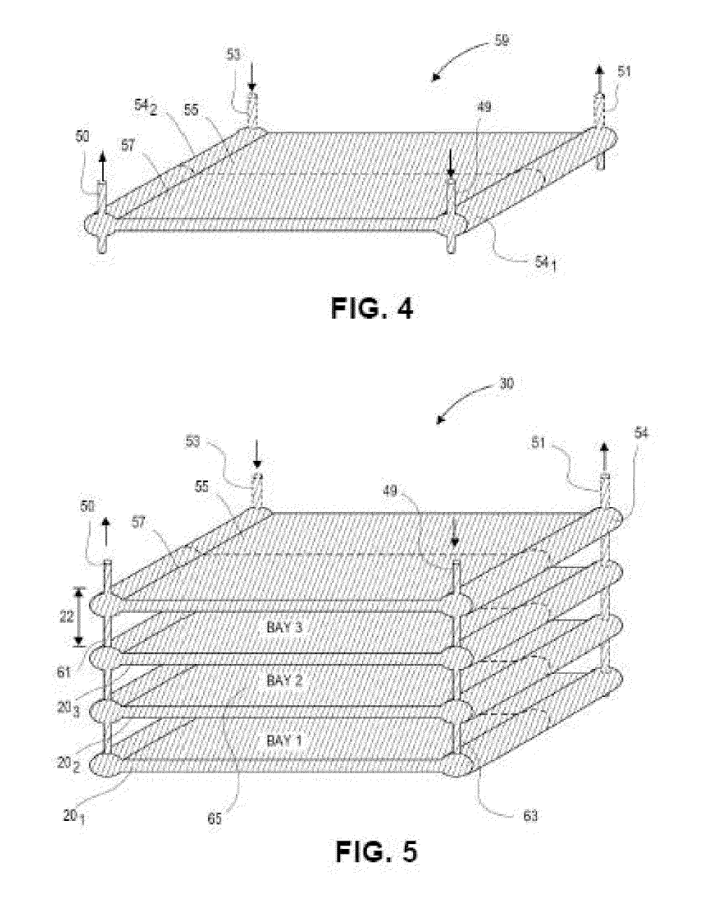

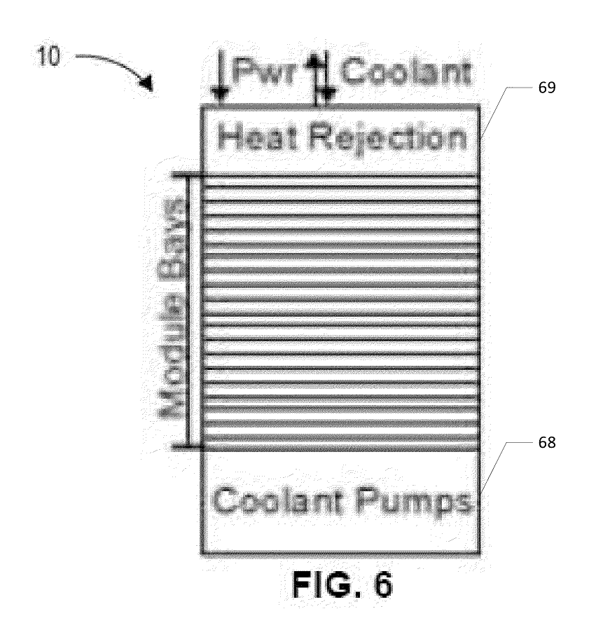

In some embodiments, rack system 10 may include a coolant system having coolant inlet 49 and coolant outlet 50. Coolant inlet 49 and coolant outlet 50 are connected to piping running down through each partition's coolant distribution nodes (e.g., coolant distribution node 54) to provide the coolant into and out of the cooled partitions. For example, coolant (e.g., refrigerant R-134a) may flow into coolant inlet 49, through a set of vertically spaced, 0.1 inch thick horizontal cooled partitions (discussed herein with reference to FIGS. 3 and 4) and out of coolant outlet 50. The coolant may be provided, for example, from an external coolant pumping unit, as shown by the arrows in FIG. 6. As discussed above, the space between each pair of adjacent cooled partitions may be defined by a module bay. Waste heat may be transferred via conduction, first from the components within each module (e.g., processing modules 32) to the module's top and bottom surfaces, and then to the cooled partitions at the top and bottom of the module bay (e.g., module bays 30). Other coolant distribution methods and hardware may also be used without departing from the scope of the embodiments disclosed herein.

In some example embodiments, instead of or in addition to having refrigerant flowing into and out of coolant inlet 49 and out of coolant outlet 50 driven by external refrigerant pumping and heat rejection infrastructure, the refrigerant flow may be driven by one or more recirculation pumps 68 integrated into rack system 10, such as in the bottom of rack system 10 as shown in FIG. 6. Additionally, the refrigerant piping may travel from the rack (e.g., the top of the rack as shown in FIG. 6) to and from heat rejection unit 69, which may be mounted on or near the rack system 10, e.g., directly on top of the rack as shown in FIG. 6, or in a separate location such as outdoors on a roof of a surrounding container or building.

According to some example embodiments, heat rejection unit 69 may be a refrigerant-to-water heat exchanger, which may be located close to rack system 10 (e.g., mounted on the top of the rack system 10). A refrigerant-to-water heat exchanger, for example, mounted on the top of rack system 10, may have cooling water flowing from an external cooling water supply line into an inlet pipe, and from an outlet pipe to an external cooling water return line. As such, coolant inlet 49 and coolant outlet 50 may be connected to the water supply and return lines, while refrigerant is used within the rack system 10 for cooling partitions 20. This refrigerant-to-water heat exchanger may be utilized when heat is being transferred into another useful application such as, for example, indoor space or water heating, or when there is a relatively large distance from the rack system to next point of heat transfer (e.g., to outdoor air).

Alternatively, in some example embodiments, the heat rejection unit may be a refrigerant-to-air heat exchanger. A refrigerant-to-air heat exchanger may utilize fan-driven forced convection of cooling air across refrigerant-filled coils, and may be located in an outdoor air environment separate from the rack system. For example, the refrigerant-to-air heat exchanger may be located on a roof of a surrounding container or building. In many instances, rejecting waste heat to outdoor air directly, eliminates the cost and complexity of the additional step of transferring heat to water and then finally to outdoor air. The use of a refrigerant-to-air heat exchanger may be advantageous in situations where there is a short distance from the rack system to the outdoor refrigerant-to-air heat exchanger.

In some embodiments, to support the internal flow of refrigerant within rack system 10, a mechanical equipment space, for example, at the bottom of the rack below the bottom-most module bay, may house a motor-driven refrigerant recirculation pump as shown in FIG. 6. Refrigerant (e.g., liquid refrigerant) may be forced upward from the pump outlet via a refrigerant-supply pipe network, into an inlet manifold on the edge (e.g., the left side) of each cooling partition 20 (see FIGS. 4 and 5) in rack system 10. The refrigerant exiting the outlet manifold on the opposite edge (e.g., the right side) of each cooling partition may be a mixture of liquid and vapor, and the ratio of liquid to vapor at the outlet depends on the amount of heat that was absorbed by the cooling partition based on a local instantaneous heat load. Via a refrigerant-return pipe network connected to the outlet manifold of each cooling partition, liquid-phase refrigerant may drain down via gravity into the inlet of the recirculation pump at the bottom of the rack. In this same refrigerant-return pipe network, vapor-phase refrigerant may travel upward to the top of the rack and then through the heat-rejection unit, where the vapor-phase refrigerant may condense back to liquid and then drain down via gravity into the inlet of the recirculation pump at the bottom of the rack.

Thus, embodiments of rack system 10 including one or all of the compact features based on modularity, cooling, power, pitch height, processing, storage, and networking, provide, among others, energy efficiency in system manufacturing, energy efficiency in system operation, cost efficiency in system manufacturing and installation, cost efficiency in system maintenance, space efficiency of system installations, and environmental impact efficiency throughout the system lifecycle.

FIG. 2 illustrates a portion of the side of rack system 10, according to some embodiments. FIG. 2 shows rack power section 19 and universal hardware platform 21 as seen from an open side and rear perspective of rack system 10. The three module bays of the module bays 30, which may receive brain boards, are made up of four cooled partitions, cooled partitions 20₁, 20₂, 20₃, and 20₄. Each module bay may include two partitions, in this embodiment an upper and a lower partition. For example, module bay 65 is the middle module bay of the three module bays, module bays 30, and has cooled partition 20₂ as the lower cooled partition and 20₃ as the upper cooled partition. As will be discussed in further detail, functional brain boards may be inserted into module bays, such as module bay 65, and thermally couple to the cooled partitions to cool the modules during operation.

The coolant distribution node 54 is illustrated on cooled partition 20₄, and in this embodiment is connected to the coolant distribution nodes of other cooled partitions throughout the rack via coolant pipe 61 running up the height of the rack and to coolant outlet 50. Similarly, a coolant pipe 63 (see e.g., FIG. 5) may be connected to the opposite end of each of the cooled partitions at a second coolant distribution node, and to coolant inlet 49.

Perimeter frame 12 of rack system 10 may include backplane mounting surface 62 where the service unit backplanes are attached to perimeter frame 12, such as cluster unit backplanes 38 and 43 of universal hardware platform 21, and rack power and management backplane 42 of rack power section 19. In various embodiments, backplane mounting surface 62 may include mounting structures that conform to a uniform standard distance or pitch size (P), such as pitch 22 shown in FIG. 1. The mounting structures on the surface of the service unit backplanes, as well as the backplanes themselves, may be configured to also conform with the standard pitch size. For example, cluster unit backplane 38 may have a height of approximately the height of module bays 30, corresponding to a pitch of P, and accordingly the structures of backplane mounting surface 62 are configured to align with the mounting structures of cluster unit backplane 38.

In various embodiments, the mounting structures for the backplane mounting surface 62 and the brain boards (e.g., brain board 28) may be magnets, rails, indentations, protrusions, bolts, screws, or uniformly distributed holes that may be threaded or configured for a fastener (e.g., bolt, pin, etc.) to slide through, attach, or snap into.

When mounted, the service unit backplanes provide a platform for the connectors of the modules (e.g., capacity providing lobe components 32 of brain board 28) to couple with connectors of the service unit backplane, such as connectors 64 and 66 of cluster unit backplane 38 and the connectors associated with the modules of cluster unit 28 described herein. The connectors are not limited to any type, and each may be, for example, an edge connector, pin connector, optical connector, or any connector type or equivalent in the art. The cooled partitions may include removable, adjustable, or permanently fixed guides (e.g., flat brackets or rails) to assist with the proper alignment of the brain boards with the connectors of the backplane upon module insertion. In another embodiment, a brain board and backplane may include one or more guide pins and corresponding holes (not shown), respectively, to assist in module alignment.

FIG. 3 is an embodiment of rack system 10 illustrating the rear portion and the open side of the rack. As shown, FIG. 3 represents only a portion of the entire rack system 10, and specifically, only portions of rack power section 19 and universal hardware platform 21. This embodiment illustrates power inlet 48 coupled to power bus 67 via rack power and management backplane 42, which as previously mentioned may convert AC power from power inlet 48 to DC power for distribution to the brain boards via the service unit backplanes of universal hardware platform 21, such as in embodiments where such conversion does not take place in each brain board.

In some embodiments, power bus 67 may include two solid conductors; a negative or ground lead and a positive voltage lead connected to rack power and management backplane 42 as shown. Power bus 67 may be rigidly fixed to rack power and management backplane 42, or may only make an electrical connection but be rigidly fixed to the backplanes as needed, such as to cluster unit backplanes 38 and 43. In other embodiments where DC power is supplied directly to power inlet 48, power bus 67 may be insulated and rigidly fixed to rack system 10. As such, power bus 67 may be configured to provide power to any functional type of backplane mounted in universal hardware platform 21. The conductors of power bus 67 may be electrically connected to the service unit backplanes by various connector types. For example, power bus 67 may be a metallic bar which may connect to each backplane using a bolt and a clamp, such as a D-clamp.

FIG. 3 also illustrates another view of the cooled partitions of the rack system 10. This embodiment shows coolant distribution node 54 that is part of the cooled partitions shown, such as cooled partitions 20₁, 20₂, 20₃, and 20₄ of module bays 30, and also shows a side view of the middle module bay, module bay 65. As discussed herein, coolant distribution node 54 may be connected to the coolant distribution nodes of the other cooled partitions via coolant pipes 61 and 63 (see e.g., FIGS. 2 and 5) running up the rack and to coolant inlet 49 and coolant outlet 50.

FIG. 4 shows an embodiment of cooled partition 59 that may receive a brain board. Cooled partition 59 may include coolant distribution nodes 54₁ and 54₂, which may be connected to coolant inlet 49 and coolant outlet 50, respectively. Cooled partition 59 may internally include channels (not shown) that facilitate coolant flow between coolant distribution nodes 54₁ and 54₂ to cool each side of cooled partition 59. The internal channels may be configured in any suitable way known in the art, such as a maze of veins composed of flattened tubing, etc. Coolant distribution nodes 54₁ and 54₂ may include additional structures to limit or equalize the rate and distribution of coolant flow along each axis of the coolant distribution node and through the cooled partition. Additionally, coolant inlet 49 and the coolant outlet 50 may be located diagonally opposite to each other, depending on the rack design and the channel design through the cooled partition 59.

In another embodiment, cooled partition 59 may be divided into two portions, partition portion 55 and partition portion 57. Partition portion 57 may include coolant inlet 49 and coolant outlet 50. However, partition portion 55 may include separate coolant outlet 51 and coolant inlet 53. Partition portions 55 and 57 may be independent of each other, each with their own coolant flow from inlet to outlet. For example, the coolant flow may enter into coolant inlet 49 of partition portion 57, work its way through cooling channels and out of the coolant outlet 50. Similarly, coolant flow may enter coolant inlet 53 of partition portion 55, then travel through its internal cooling channels and out of coolant outlet 51. In another embodiment, coolant inlet 49 and coolant inlet 53 may be on the same side of partition portion 55 and partition portion 57, respectively. Having the coolant inlets and outlets on opposite corners may provide more balanced cooling characteristics throughout cooled partition 59.

In some embodiments, partition portions 55 and 57 may be connected such that coolant may flow from one partition portion to the next through either one or both of coolant distribution nodes 54₁ and 54₂, and through each partition portions' cooling channels. Based on known coolant flow characteristics, it may be more beneficial to have coolant inlet 49 and coolant inlet 53 both on the same side of partition portion 55 and partition portion 57, and similarly outlets 50 and 51 both on the opposite side of partition portions 55 and 57.

Some high-density direct-conduction cooling systems may require the heat-dissipating components to be shut down quickly if coolant flow stops due to, for example, mechanical failure in the cooling system or required maintenance activities. To assist in addressing this concern, multiple independent and redundant coolant circuits may be integrated into rack system 10. Therefore, if coolant flow in one circuit stops due to, for example, mechanical failure or required maintenance activities, the remaining coolant circuits may continue to function, thereby enabling continued operation of the heat-dissipating components.

In this regard, each cooling partition 20 may be divided into two or more separate strips, such as with each strip traveling from left to right across the rack. Each independent strip may be connected to a single coolant circuit. Multiple independent coolant circuits may be provided in the rack, arranged such that if cooling in a single coolant circuit is lost due to failure or shutdown, every cooling partition 20 in the rack will continue to provide cooling via at least one strip connected to a still-functioning coolant circuit. For example, a dual redundant configuration could have one strip traveling from left to right near the front of rack system 10, and in the same plane another separate strip traveling from left to right near the rear of rack system 10. As such, the effectiveness of cooling redundancy can be enhanced via front-to-back heat-spreading thermal plates forming the top and bottom surfaces of modules (e.g., capacity providing lobe components 32 of brain board 28). Such plates can make it possible for all components in the module to be cooled simultaneously and independently by each of the separate cooling-partition strips in a redundant configuration. If any one of the redundant strips stops cooling temporarily due to, for example, a mechanical failure or required maintenance activities, all components in the module can continue to be cooled, albeit possibly at reduced cooling capacity that might necessitate load-shedding or other means to temporarily reduce power dissipation within the module.

Additional cooling system redundancies can also be integrated in rack system 10. For example, multiple redundant recirculation pumps at the bottom of the rack may be included (e.g., one for each cooling circuit), and multiple redundant refrigerant-to-water or refrigerant-to-air heat exchangers may be included, possibly installed on the top of rack system 10.

FIG. 5 shows an embodiment of cooled partitions 20₁, 20₂, 20₃, and 20₄ of module bays 30 removed from rack system 10, and provides another illustration of module bay 65. Each cooled partition may have the same functionality as described in FIG. 4 with respect to cooled partition 59. Each cooled partition is physically connected by coolant pipe 61 and coolant pipe 63, which may provide system wide coolant flow between all cooled partitions within rack system 10. As with cooling partition 59 of FIG. 4, in another embodiment cooled partitions 20₁, 20₂, 20₃, and 20₄ may have additional coolant outlet 51 and coolant inlet 53 and associated piping similar to coolant pipes 61 and 63. In other embodiments, the configuration of the inlets and outlets may vary depending on the desired coolant flow design. For example, the two inlets may be on diagonally opposite corners or on the same side, depending on the embodiment designed to, such as including partition portions, etc., as discussed herein with reference to FIG. 4.

In some embodiments, the bottom and top surfaces of cooled partitions 20₁, 20₂, 20₃, and 20₄ are heat conductive surfaces. Because coolant flows between these surfaces, they are suited to conduct heat away from any fixture or apparatus placed in proximity to or in contact with either the top or bottom surface of the cooled partitions, such as the surfaces of cooled partitions 20₂ and 20₃ of module bay 65. In various embodiments, the heat conductive surfaces may be composed of any combination of many heat conductive materials known in the art, such as aluminum alloy, copper, etc. In another embodiment, the heat conductive surfaces may be a mixture of heat conducting materials and insulators, which may be specifically configured to concentrate the conductive cooling to specific areas of the apparatus near or in proximity to the heat conductive surface.

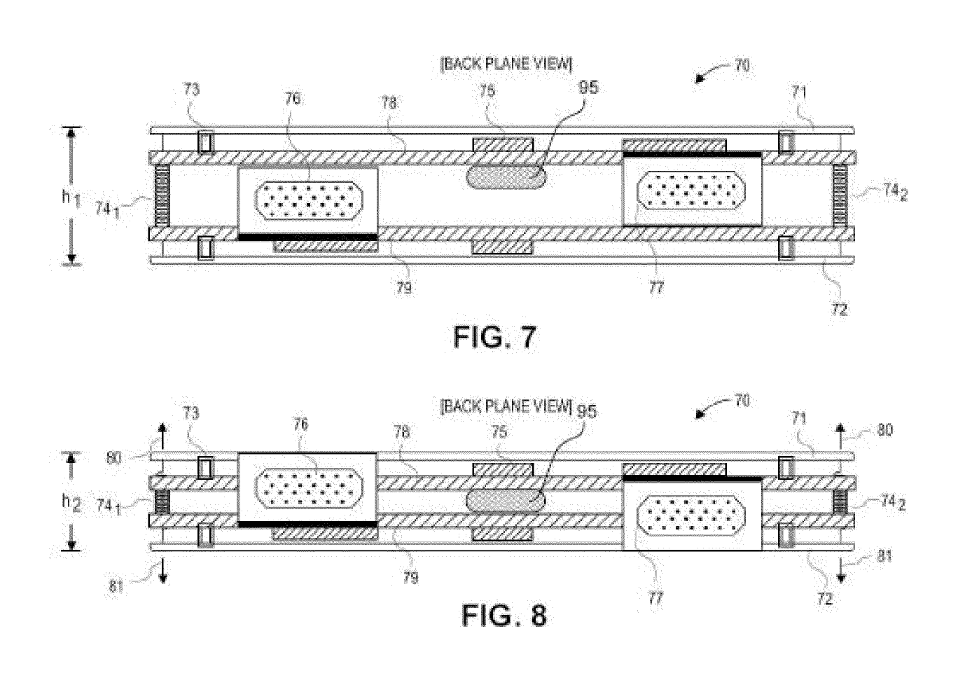

FIGS. 7 and 8 are each embodiments of a module fixture 70, which may include one or more brain boards, such as brain board 28 discussed above, onto which lobe components may be coupled. The lobe components can be configured to provide at least some of the functionality of network-based services as discussed herein. Module fixture 70 may include thermal plates 71 and 72, fasteners 73, tensioners 74₁ and 74₂, lobe component 75 (among others not labeled to avoid overcomplicating the drawing and discussion thereof), connector 76, connector 77, brain boards 78 and 79, and power storage component 95.

In some embodiments, brain boards 78 and 79 may comprise multi-layered printed circuit boards (PCBs) and can be configured to include connectors and components, such as lobe component 75, to provide networking functionality. In various embodiments, brain board 78 and brain board 79 may have the same or different layouts and/or functionality. Brain boards 78 and 79 may include connector 77 and connector 76, respectively, to provide input and output via a connection to the backplane (e.g., cluster unit backplane 38) through pins or other connector types known in the art, such as those discussed in connection with BPC 120. Lobe component 75 may be an example component, and it can be appreciated that a brain board may include many components of various sizes, shapes, and functions that all may receive the unique benefits of the cooling, networking, power, management, and form factor of rack system 10. For example, in some embodiments, one or more additional components, such as power storage component 95, may be located on the opposite, non-cooled side of brain board 78. As noted above (e.g., in connection with power lobe component 36 and/or power circuitry 36B), power storage component 95 may be a super capacitor, battery and/or any other suitable power storage component than may enable the lobe component(s) and/or other components of brain board 70 to continue operating even if there is a disruption in the mains power supply to rack system 10.

In some embodiments, brain board 78 may be mounted to thermal plate 71 using fasteners 73 and, as discussed herein, can be in thermal contact with at least one cooled partition when installed into rack system 10. In some embodiments, fasteners 73 may include a built in standoff that permits the boards' components (e.g., lobe component 75) to be in close enough proximity to thermal plate 71 to create a thermal coupling to lobe component 75 and component board 78. In some embodiments, brain board 79 may be opposite to brain board 78, and may be mounted and thermally coupled to thermal plate 72 in a similar fashion as brain board 78 to thermal plate 71.

Because of the thermal coupling of thermal plates 71 and 72—which may be cooled by the cooling partitions (such as those shown in FIGS. 4 and 5) of rack system 10—and the components of the attached boards, (e.g., brain board 78 and lobe component 75) there may be no need to attach heat-dissipating elements, such as heat sinks or heat spreaders, directly to the individual components. This allows module fixture 70 to have a lower profile, permitting a higher density of module fixtures, components, and functionality in a single rack system, such as rack system 10 and in particular the portion that is universal hardware platform 21.

In some embodiments, when a component is sufficiently taller than another component mounted on the same component board, the lower height component (such as memory) may not have a sufficient thermal coupling to the thermal plate for proper cooling. In this case, the lower height component may include one or more additional heat-conducting elements to ensure an adequate thermal coupling to the thermal plate. In some embodiments, a heat conductive glue or other material can be used to fill any gap between the thermal plate and each of the components, while also providing mechanical attachment of the components and the brain board to the thermal plate.

In some embodiments, the thermal coupling of thermal plates 71 and 72 of module fixture 70 may be based on direct contact of each thermal plate to its respective cooled partition, such as module bay 65 which includes cooled partitions 20₃ and 20₄ shown in FIGS. 2, 3, and 5 above. To facilitate the direct contact, thermal plates 71 and 72 may each connect to an end of a tensioning device, such as tensioners 74₁ and 74₂. In one embodiment, the tensioners are positioned on each side and near the edges of the thermal plates 71 and 72. For example, tensioners 74₁ and 74₂ may be springs in an uncompressed state resulting in a module fixture height h₁, as shown in FIG. 7, where h₁ is larger than the height of the module bay 65 including cooled partitions 20₃ and 20₄.

FIG. 8 illustrates module fixture 70 when thermal plates 71 and 72 are compressed towards each other to a height of h₂, where h₂ is less than or equal to the height or distance between cooled partitions 20₃ and 20₄ of module bay 65. Thus, when the module fixture is inserted into module bay 65 there is an outward force 80 and an outward force 81 created by the compressed tensioners 74₁ and 74₂. These outward forces provide a physical and thermal contact between cooled partitions 20₃ and 20₄ and thermal plates 71 and 72. As coolant flows through each partition, as described with respect to FIGS. 4-6, it conductively cools the boards and components of module fixture 70.

Tensioners 74₁ and 74₂ may be of any type of spring or material that provides a force enhancing contact between the thermal plates and the cooling partitions. Tensioners 74₁ and 74₂ may be located anywhere between thermal plates 71 and 72, including the corners, the edges, or the interior, and have no limit on how much they may compress or uncompress. For example, the difference between h₁ and h₂ may be as small as a few millimeters, or as large as several centimeters. In other embodiments, tensioners 74₁ and 74₂ may pass through the mounted brain boards, or be located between and coupled to the brain boards, or any combination thereof. The tensioners may be affixed to the thermal plates or boards by any fastening hardware, such as screws, pins, clips, etc.

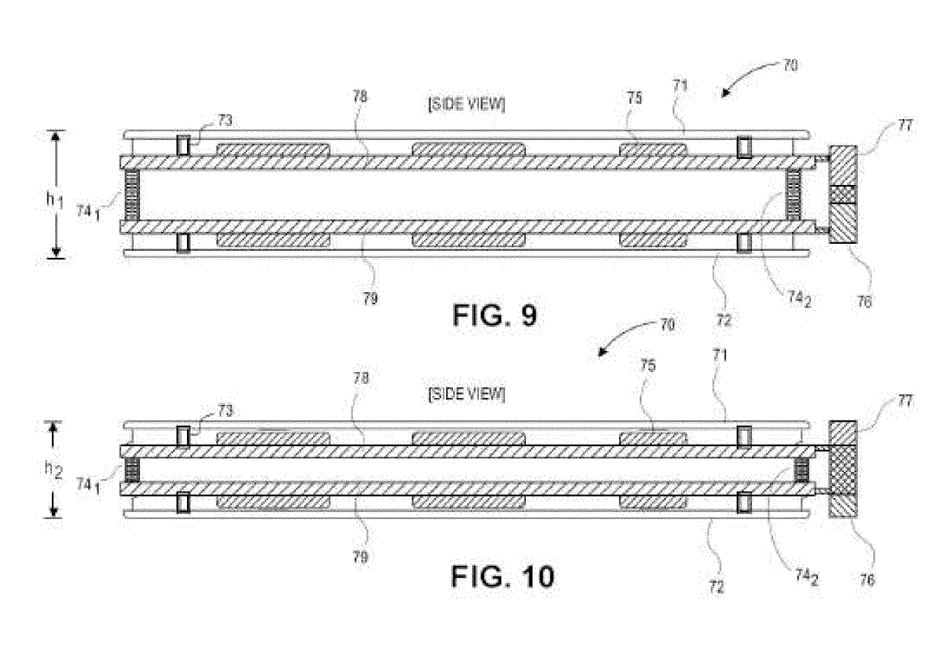

FIGS. 9 and 10 show an embodiment of module fixture 70 from a side view, in an uncompressed and compressed state respectively. As shown in FIGS. 7 and 8, connectors 76 and 77 do not overlap, and in this embodiment are on different sides as seen from the back plane view. FIGS. 9 and 10 further illustrate that connectors 76 and 77 may extend out from the edges of thermal plates 71 and 72, such that they may overlap the thermal plates when module fixture 70 is compressed down to the height of h₂. For example, when the module fixture 70 is compressed down to the height of h₂, connector 76 of bottom component board 79 may be relatively flush with thermal plate 71 on top, and connector 77 of top component board 78 may be relatively flush with thermal plate 72 on the bottom. In this particular embodiment, connectors 76 and 77 may define the minimum h₂, or in other words, how much module fixture 70 may be compressed. Maximizing the allowable compression of module fixture 70 enables the smallest possible pitch (P) between cooling partitions, and the highest possible density of functional components in rack system 10, such as universal hardware platform portion 21 of rack system 10.

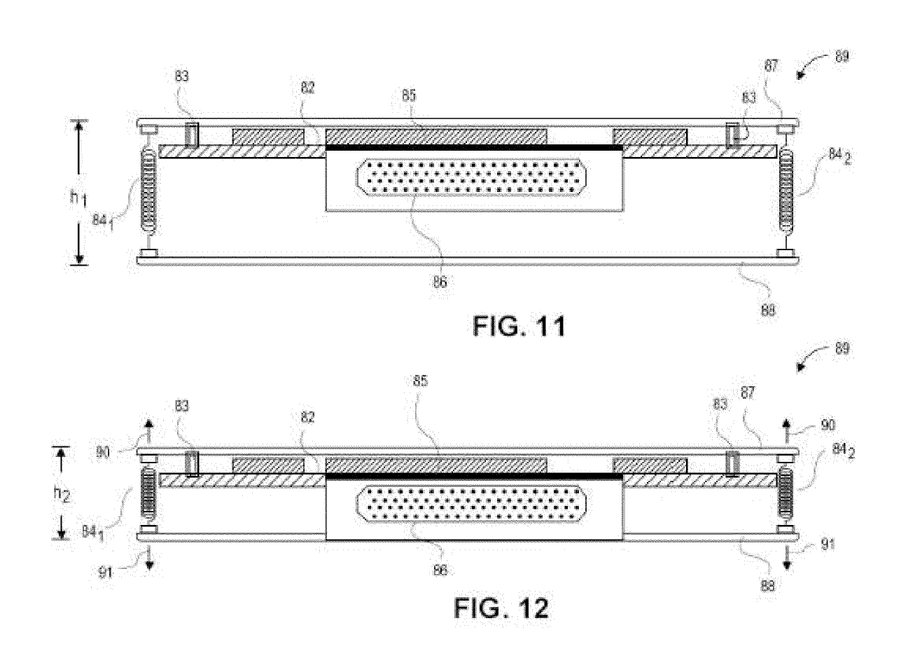

FIGS. 11 and 12 are each embodiments of module fixture 89 for a rack power board insertable into rack power section 19 of rack system 10. Module fixture 89 may include thermal plates 87 and 88, fasteners 83, tensioners 84₁ and 84₂, component 85, connector 86, and component board 82. In some embodiments, each of the other brain boards can include power circuitry, such as power lobe component 36 and/or power circuitry 36B discussed in connection with FIGS. 1A and 1B, thereby obviating the need for the rack power boards shown in FIGS. 11 and 12.

In a similar way as described above with respect to the module fixture 70 in FIGS. 7 and 8, when module fixture 89 is inserted into a module bay in rack power section 19 there may be an outward force 90 and an outward force 91 created by compressed tensioners 84₁ and 84₂. These outward forces enhance the physical and thermal contact between the cooled partitions of rack power section 19 and thermal plates 87 and 88. Therefore, component board 82 and components (e.g., component 85) of module fixture 89 may be conductively cooled as coolant flows through the relevant cooled partitions.

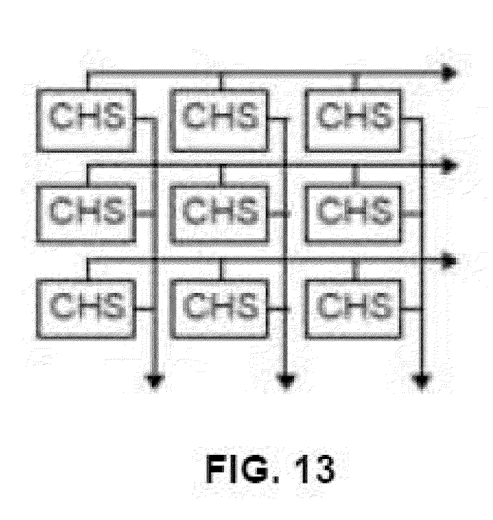

The embodiments described above and otherwise herein may provide for compact provision of network switching, processing, and storage resources with efficient heat removal within a rack system and/or other type of chassis. In some situations, it may be desirable to provide a highly robust computing environment (e.g., a supercomputer or cloud computing system) by ganging together resources from multiple rack systems. In an example embodiment, an architecture for providing a robust computing system can be provided by employing a topology as described herein. FIG. 13 illustrates an arrangement of a plurality of rack units (e.g., rack systems 10) to provide interconnection thereof for a robust computing environment according to an example embodiment. In this regard, nine rack units or other chasses (CHS) are provided in three sets of adjacent rows of three units each. Similar configuration can be applied, in some embodiments, to brain boards in each rack and/or lobe components on each brain board.

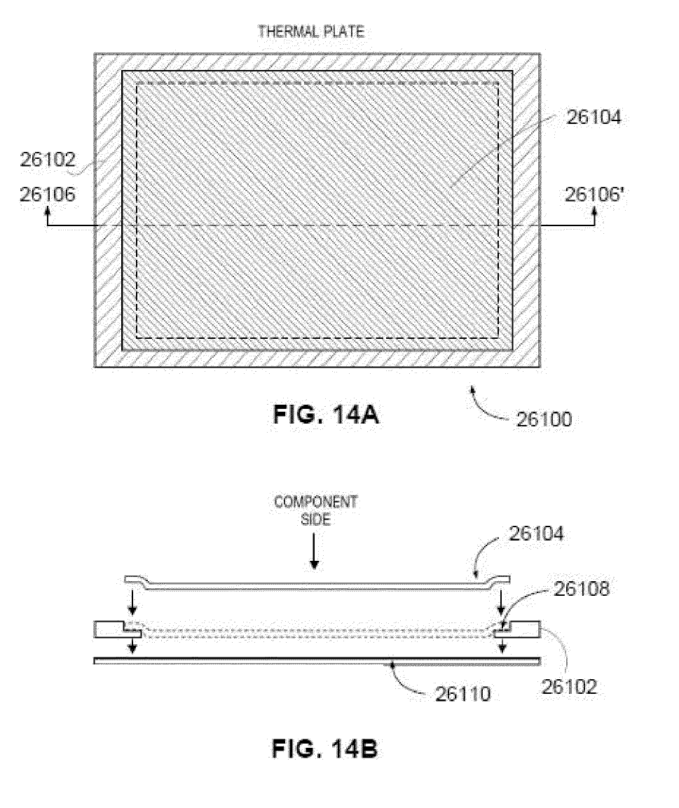

FIG. 14A provides a top view of the thermal plate 26100. Meanwhile, FIG. 14B illustrates a cross section of the thermal plate 26100 taken along line 26106-26106′. The frame 26102 may be constructed to extend around the perimeter of the heat exchanger insert 26104 to provide a support platform 26108 to support edges of the heat exchanger insert 26104, while enabling a large portion of the surface area of the heat exchanger insert 26104 to come into contact with a cooling shelf 26110 of a cooling partition (e.g., cooling partition 59) to facilitate heat transfer. In some embodiments, although the frame 26102 may be rigidly constructed, the heat exchanger insert 26104 may be made from a flexible material such that the heat exchanger insert 26104 may be bowed outward with respect to an inner side of the thermal plate 26100, which may be proximate to components of a module fixture (e.g., components of a component unit including a component board upon which components are mounted). The heat exchanger insert 26104 may be any material or structure that is conducive to conducting heat in an efficient manner. Thus, for example, in some cases, the heat exchanger insert 26104 may be embodied as a flat heat pipe or other similar structure.

The bowing, which is illustrated in FIG. 14B, may provide a contact bias between an outer surface of the thermal plate 26100 and the cooling shelf 26110. The contact bias may enable a majority of the heat exchanger insert 26104 to be in contact with the cooling shelf 26110, to increase heat transfer away from components of the module fixture for removal via thermal coupling with the cooling shelf 26110. In some embodiments, a thermal conducting filler material may be placed between components of the module fixture and the heat exchanger insert 26104, to further facilitate heat transfer away from the components. Moreover, when either a component side or a non-component side of a component board of the component unit is proximate to the heat exchanger insert 26104, the heat exchanger insert 26104 may remove heat efficiently from the component unit.

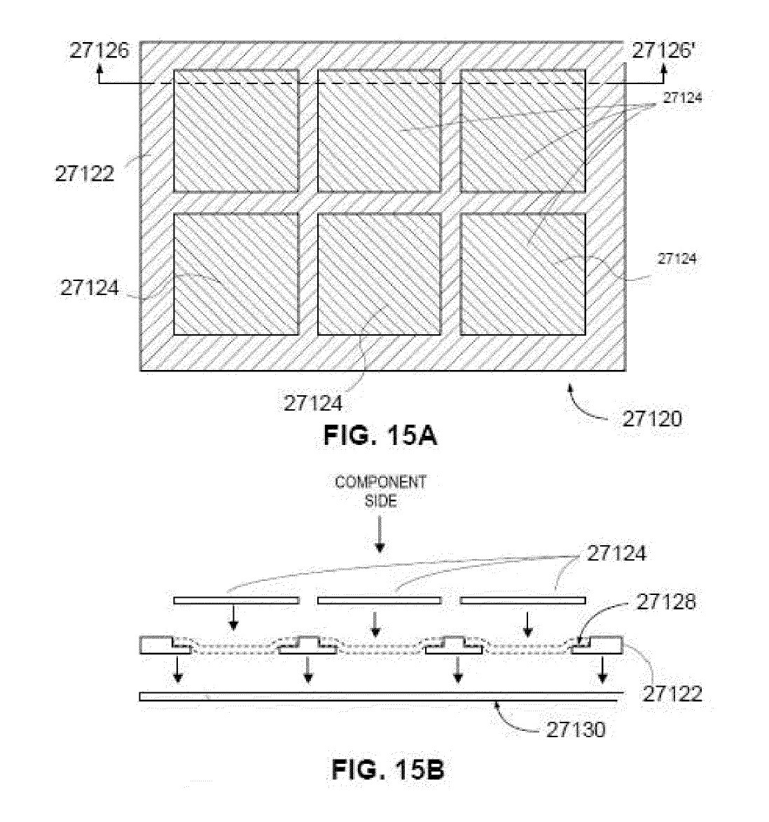

Although the thermal plate 26100 of FIGS. 14A and 14B includes a single heat exchanger insert 26104, multiple heat exchanger inserts may be provided in alternative embodiments. FIGS. 15A and 15B show an example of a thermal plate 27120 having a frame 27122 including multiple insert receptacles for supporting a corresponding number of heat exchanger inserts 27124, to illustrate such an alternative embodiment. The multiple insert receptacles may substantially take the form of a window frame structure, where each of the “window panes” corresponds to a heat exchanger insert 27124. In this regard, FIG. 15A provides a top view of the thermal plate 27120. Meanwhile, FIG. 15B illustrates a cross section of the thermal plate 27120 taken along line 27126-27126′. The frame 27122 may be constructed such that the insert receptacles extend around the perimeter of each respective one of the heat exchanger inserts 27124, to provide a support platform 27128 to support edges of the heat exchanger inserts 27124, while enabling a large portion of the surface area of the heat exchanger inserts 27124 to come into contact with a cooling shelf 27130 of a cooling partition (e.g., cooling partition 59) to facilitate heat transfer.

Similarly, the frame 27122 may be rigidly constructed and the heat exchanger inserts 27124 may be made from a flexible material, such that the heat exchanger inserts 27124 may be bowed outward with respect to an inner side of the thermal plate 27120. The inner side of the thermal plate 27120 may be proximate to components of a module fixture and may be thermally coupled to these components via a thermal conducting filler, as described herein. However, in some embodiments, the components may be mounted to the frame 27122, and heat may be passed from the frame to the heat exchanger inserts 27124, such that the heat exchanger inserts 27124 act as a heat spreader to more efficiently dissipate heat away from the components.

As shown in FIG. 15B, the bowing of the heat exchanger inserts 27124 may provide a contact bias between an outer surface of the thermal plate 27120 and the cooling shelf 27130. The contact bias may enable a majority of the heat exchanger inserts 27124 to be in contact with the cooling shelf 27130, to increase heat transfer away from components of the module fixture for removal via thermal coupling with the cooling shelf 27130. Moreover, when either a component side or a non-component side of the component board of the component unit is proximate to the heat exchanger inserts 27124, the heat exchanger inserts 27124 may remove heat efficiently from the component unit.

In an exemplary embodiment, the module fixture 89 of FIGS. 11 and 12 or the module fixture 70 of FIGS. 7-10 may be inserted into one of the bays (e.g., module bay 65) of FIG. 5. The tensioners (e.g., tensioners 84₁ and 84₂ of FIGS. 11 and 12 or tensioners 74₁ and 74₂ of FIGS. 7-10, respectively) may bias thermal plates associated with each respective module fixture outward, to enhance contact between the corresponding thermal plates and the corresponding sides of each cooled partition (e.g., cooled partition 59) of the bays. The cooling provided to the cooled partition 59 may be provided by virtue of passing coolant (e.g., a refrigerant, water, and/or the like) from the coolant inlet 49 to the coolant outlet 50.

In any case, some exemplary embodiments may provide for mechanisms to facilitate efficient heat removal from module fixtures in a rack system capable of supporting a plurality of data networking, processing, and/or storage components. Accordingly, a relatively large capacity for reliable computing may be provided and supported in a relatively small area, due to the ability to efficiently cool the heat-dissipating components within the rack system.

As mentioned above, each of the service units or modules that may be housed in the rack system 10 may provide some combination of data networking, processing, and storage capacity, enabling the service units to provide functional support for various data-related activities (e.g., as processing units, storage arrays, network switches, etc.). Some example embodiments of the present invention provide a mechanical structure for the rack system and the service units or modules that provides for efficient heat removal from the service units or modules in a compact design. Thus, the amount of data networking, processing, and storage capacity that can be provided for a given amount of cost may be increased, where elements of cost include manufacturing cost, lifecycle maintenance cost, amount of space occupied, and operational energy cost.

Some example embodiments may enable networking of multiple rack systems 10 to provide a highly scalable modular architecture. In this regard, for example, a plurality of rack systems could be placed in proximity to one another to provide large capacity for processing and/or storing data within a relatively small area. Moreover, due to the efficient cooling design of rack system 10, placing a plurality of rack systems in a small area may not require additional environmental cooling requirements beyond the cooling provided by each respective rack system 10. As such, massive amounts of data networking, processing, and storage capacity may be made available with a relatively low complexity architecture and a relatively low cost for maintenance and installation. The result may be that potentially very large cost and energy savings can be realized over the life of the rack systems, relative to conventional data systems. Thus, embodiments of the present invention may have a reduced environmental footprint relative to conventional data systems.

Another benefit of the efficient architecture of rack system 10 described herein, which flows from the ability to interconnect multiple rack systems in a relatively small area, is that such interconnected multiple rack systems may be implemented on a mobile platform. Thus, for example, a plurality of rack systems may be placed in a mobile container such as an inter-modal shipping container. The mobile container may have a size and shape that is tailored to the specific mobile platform for which implementation is desired (e.g., truck, ship, submarine, aircraft, etc.). Accordingly, it may be possible to provide very robust data networking, processing, and storage capabilities in a modular and mobile platform. Some additional examples related to implementing racks in a mobile container are discussed in commonly-invented U.S. Pat. No. 8,259,450, titled “Mobile Universal Hardware Platform,” which is incorporated by reference herein in its entirety.

Further, embodiments discussed herein can be configured to delivers ten times or more the efficiency improvements relative to current systems, enabling massively scalable systems with dramatically lower capital and maintenance costs, energy requirements, weight, and physical footprint per unit of delivered NPS capacity. For example, overall mission effectiveness of military subsurface, surface, and air platforms can be greatly enhanced by improving the efficiency of interconnected onboard and remote data systems that integrate Sensing, Networking, Processing, and Storage capabilities.

Military platforms are integrating an increasing number of sophisticated data systems. Many of these systems employ unique, highly specialized, dedicated hardware, system software, and communication protocols to support a single embedded application. While single-application dedicated systems will continue to play an important role, there are numerous on-platform data applications that could operate much more efficiently if migrated to a highly scalable general-purpose shared-resource platform. In this regard, some embodiments support cloud-style agile provisioning of pooled virtualized resources to a dynamic set of concurrently running applications. Benefits of some embodiments implementing this shared-resource approach can include: entirely new capabilities enabled by greatly increasing the NPS capacity that can be deployed within the power, space, weight, and other resource constraints of existing military platforms; additional new capabilities enabled by interconnection of previously isolated/standalone data applications; enablement use of higher-productivity software-development environments from the web/cloud development world, which can reduce time and cost to develop and deploy new and enhanced applications, via general-purpose hardware and system-software infrastructure that facilitates addition of new functionality at the application-software level; significantly reduced platform-wide acquisition cost per unit of deployed NPS capacity, via a shared scalable data system that takes maximum advantage of the volume economics of COTS hardware and software building blocks; improved platform-wide reliability and availability of data systems, via a simplified and integrated architecture that eliminates entire categories of components such as discrete networking and storage units, and resource pooling that reduces the number of unique single points of failure; platform-wide simplification of data systems maintenance, facilitated by a modular common data system design with a single primary unit of replication; platform-wide improvement in data system hardware resource utilization efficiency, via consolidation of multiple standalone systems, which can result in space and weight savings to be used to extend platform payload capacity and/or fuel-limited operational range.

Although embodiments have been described herein with reference to specific example embodiments, it will be evident that various modifications and changes may be made to these embodiments without departing from the broader spirit and scope of the invention. Accordingly, the specification and drawings are to be regarded in an illustrative rather than a restrictive sense.

In the foregoing Detailed Description, it can be seen that various features are sometimes grouped together in single embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A module for insertion in a rack based system, comprising:
a brain board;
a plurality of lobe components each configured to support a variable composition of processing and storage elements, wherein each of the plurality of lobe components is coupled with the brain board;
a network switch component configured to provide network data communication for the plurality of lobe components, wherein the network switch component is coupled with the brain board; and
a power lobe component configured to provide power received from the rack based system to the plurality of lobe components, wherein the power lobe component is coupled with the brain board; and
wherein the module is configured to thermally couple with the rack based system to receive cooling from the rack based system.

2. The module of claim 1, wherein:
the plurality of lobe components include a first lobe component and a second lobe component; and
the first lobe component includes a greater number of processing elements than the second lobe component.

3. The module of claim 1, wherein:
the plurality of lobe components include a first lobe component and a second lobe component; and
the first lobe component includes a greater number of storage elements than the second lobe component.

4. The module of claim 1, wherein:
the plurality of lobe components include a first lobe component; and
the first lobe component further includes power circuitry configured to:
receive the power from the power lobe component; and
convert the power to a format suitable for the processing and storage elements of the first lobe component.

5. The module of claim 1, wherein:
the power lobe component is further configured to:
store energy; and
provide backup power to the brain board.

6. The module of claim 1, wherein:
the plurality of lobe components include a first lobe component; and
the first lobe component further includes a network link configured to provide data communication between the processing elements of the first lobe component and the network switch component.

7. The module of claim 1, wherein:
the brain board includes a printed circuit board; and
the plurality of lobe components, the network switch component, and the power lobe component are coupled to a first side of the printed circuit board.

8. The module of claim 7, wherein the brain board further includes a power storage component coupled to a second side of the printed circuit board.

9. The module of claim 1, further comprising a first thermal plate, wherein the brain board is thermally coupled with the first thermal plate.

10. The module of claim 9, further comprising a second brain board thermally coupled with a second thermal plate.

11. The module of claim 9, wherein, when inserted between a first shelf and a second shelf of the rack based system, the module is configured to transfer heat away from the first thermal plate via a cooling source coupled to the first shelf and the second shelf.

12. The module of claim 9, further comprising a second thermal plate and wherein the first thermal plate and the second thermal plate are separated by a distance h and the distance h between the first thermal plate and the second thermal plate is configured to be adjustable.

13. The module of claim 9, further comprising a second thermal plate and one or more tensioning units coupled to and located between the first thermal plate and the second thermal plate, the one or more tensioning units configured to generate a bias that urges the first thermal plate away from the second thermal plate.

14. The module of claim 9, wherein the first thermal plate includes a frame and a heat exchanger coupled to the frame.

15. The module of claim 1, wherein the module is configured to conform to a standard distance defined by a cooled partition of the rack based system.

16. The module of claim 1, wherein the module is separate from coolant plumbing of the rack based system.

17. A method for optimizing performance of a rack based system, comprising:
determining computing requirements for the rack based system;
modifying a lobe component of a plurality of lobe components coupled with a brain board based on the computing requirements, wherein:
the brain board and the plurality of lobe components are located in a module of the rack based system;
the plurality of lobe components are each configured to support a variable composition of processing and storage elements; and
the module is configured to thermally couple with the rack based system to receive cooling from the rack based system.

18. The method of claim 17, wherein modifying the lobe component includes replacing a storage element of the lobe component with a processing element.

19. The method of claim 17, wherein modifying the lobe component includes replacing a processing element of the lobe component with a storage element.

20. The method of claim 17 further comprising removing the module from the rack based system before modifying the lobe component, wherein the module is removed from the rack based system without disconnecting coolant plumbing of the rack based system.
